(19) United States
(12) Patent Application Publication
(10) Pub. No.: US 2015/0230649 A1
(43) Pub. Date: Aug. 20, 2015

(54) COOKING ASSEMBLY WITH TILT ASSIST

(71) Applicants: Jeffrey L. Frock, Troy, OH (US); Michael B. Reckner, Dayton, OH (US); Timothy L. Cupp, Hillsboro, OH (US); Larry W. Lyons, Hillsboro, OH (US)

(72) Inventors: Jeffrey L. Frock, Troy, OH (US); Michael B. Reckner, Dayton, OH (US); Timothy L. Cupp, Hillsboro, OH (US); Larry W. Lyons, Hillsboro, OH (US)

(21) Appl. No.: 14/181,642

(22) Filed: Feb. 15, 2014

(51) Int. Cl. A47J 27/00

(52) U.S. Cl. CPC A47J 27/002

(57) ABSTRACT

A cooking assembly includes a frame and a cooking receptacle with an opening for placement of product into a cooking space of the receptacle. The cooking receptacle is pivotally mounted to the frame for rotation about a pivot axis between an upright position and a tilted position. A damper arrangement is operatively connected to dampen rotary motion of the cooking receptacle. The damper arrangement may include one or more linear dampers of the hydraulic or pneumatic type. The cooking receptacle may be a cooking kettle, such as a jacketed kettle, or other device, such as a brazing pan.

### TECHNICAL FIELD

This application relates generally to commercial cooking devices such as kettles and, more specifically, to a cooking device including a tilt arrangement.

### BACKGROUND

In commercial kitchens (e.g., found in restaurant, cafeteria and retail environments) cooking kettles are often utilized to cook relatively large volumes of food product, such as soups. It is known to provide such kettles with a tilt arrangement that allows the kettle to be tilted downward in order to empty the kettle of its contents.

To supply a tilting function for a cooking kettle, a gear reducer may be employed. Limitations in the quality of gearmesh, inherent to such gear reducer assemblies, can introduce an uneven “chattering” in the tilting motion of the kettle, particularly when the gear reducer is required to deliver higher levels of torque.

It would be desirable to provide a cooking kettle, or other cooking device, with a tilting arrangement in which chatter is alleviated and/or the gear reducer that is used can be less expensive while still providing suitable performance.

### SUMMARY

In one aspect, a cooking assembly includes a frame and a cooking receptacle, the cooking receptacle having a opening for placement of product into a cooking space of the cooking receptacle. The cooking receptacle is pivotally mounted to the frame for rotation about a pivot axis between an upright position and a tilted position. A damper arrangement is operatively connected to dampen rotary motion of the cooking receptacle.

In one implementation, the damper arrangement includes a torque arm operatively connected for rotation with the cooking receptacle and at least one damper having a first end mounted to the frame and a second end mounted to the torque arm at a location spaced from the pivot axis.

In one implementation the damper is of a linear type that is extendable and retractable as the cooking receptacle is rotated back and forth between the upright position and the tilted position.

In one implementation, the first end of the damper is pivotally mounted to a fixed location on the frame and the second end of the damper is pivotally mounted to the torque arm.

In one implementation, the damper arrangement includes a multi-function linear damper that includes dampen on extension, dampen on compression and extension force.

In one implementation, a gear reducer is operatively connected between a tilt actuator and the cooking receptacle.

In one implementation, the cooking receptacle is a kettle body, the actuator is a manual handle that is operatively connected to the gear reducer, and the gear reducer is operatively connected to rotate a shaft that is aligned with the pivot axis and operatively connected to the kettle body. The damper arrangement includes a torque arm operatively connected to the shaft for rotation with the shaft and the kettle body and at least one damper having a first end mounted to the frame and a second end mounted to the torque arm at a location spaced from the pivot axis.

In another implementation, the cooking receptacle is a kettle body, the actuator is a powered device that is operatively connected to the gear reducer, and the gear reducer is operatively connected to rotate a shaft that is aligned with the pivot axis and operatively connected to the kettle body. The damper arrangement includes a torque arm operatively connected to the shaft for rotation with the shaft and the kettle body and at least one damper having a first end mounted to the frame and a second end mounted to the torque arm at a location spaced from the pivot axis.

In another aspect, a cooking kettle assembly includes a frame and a kettle body. The kettle body has a top opening for placement of product into a cooking volume of the kettle body. The kettle body is pivotally mounted to the frame for rotation about a pivot axis between an upright position and a tilted position. An actuator is operatively connected for effecting pivot of the kettle body between the upright position and the tilted position. A torque arm is operatively connected so as to rotate with the kettle body about the pivot axis simultaneous with the kettle body. A damper has a first end pivotally mounted at a fixed location on the frame, and a second end pivotally mounted to the torque arm at a location spaced from the pivot axis. The damper is extendable and retractable as the kettle body is rotated back and forth between the upright position and the tilted position.

In one implementation, the damper is a multi-function damper that includes dampen on extension, dampen on compression and extension force.

In one implementation, a gear reducer is operatively connected between the actuator and the kettle body.

In one implementation, the actuator is a manual handle that is operatively connected to the gear reducer, and the gear reducer is operatively connected to rotate a shaft that is aligned with the pivot axis and operatively connected to the kettle body.

In one implementation, the torque arm is operatively connected to the shaft.

In one implementation, a first end of the shaft is operatively connected to the kettle body, the torque arm is operatively connected to a second end of the shaft and the gear reducer engages the shaft between the first end and the second end.

In one implementation, the actuator is a powered device that is operatively to the gear reducer, and the gear reducer is operatively connected to rotate a shaft that is aligned with the pivot axis and operatively connected to the kettle body.

In one implementation, the damper is a first damper member, the fixed location is a first location and the cooking kettle assembly further comprises a second damper having a first end pivotally mounted at a second fixed location on the frame, and a second end pivotally mounted to the torque arm at a location spaced from the pivot axis, where the second damper is extendable and retractable as the kettle body is rotated back and forth between the upright position and the tilted position.

In one implementation, the cooking kettle assembly further includes a third damper having a first end pivotally mounted at a third fixed location on the frame, and a second end pivotally mounted to the torque arm at a location spaced from the pivot axis, and the third damper is extendable and retractable as the kettle body is rotated back and forth between the upright position and the tilted position, wherein the first damper is configured to dampen on extension, the second damper is configured to dampen on compression and the third damper is configured to provide extension force.

In one implementation, the cooking volume of the kettle body is at least 20 gallons.

In one implementation, a heating system is provided to heat contents with the kettle body.

In one implementation, the damper extends as the kettle body rotates from the upright position to the tilted position, and the damper compresses as the kettle body rotates from the tilted position to the upright position.

### BRIEF DESCRIPTION OF THE DRAWINGS

FIG. 1 is a perspective view of one embodiment of a cooking kettle assembly;

FIG. 2 is a side elevation view of the cooking kettle assembly of FIG. 1 with a side panel of the housing removed;

FIG. 3 is an enlarged detailed side elevation view of FIG. 2;

FIGS. 4 and 5 are side elevation views showing an alternative damper arrangement including multiple dampers.

### DETAILED DESCRIPTION

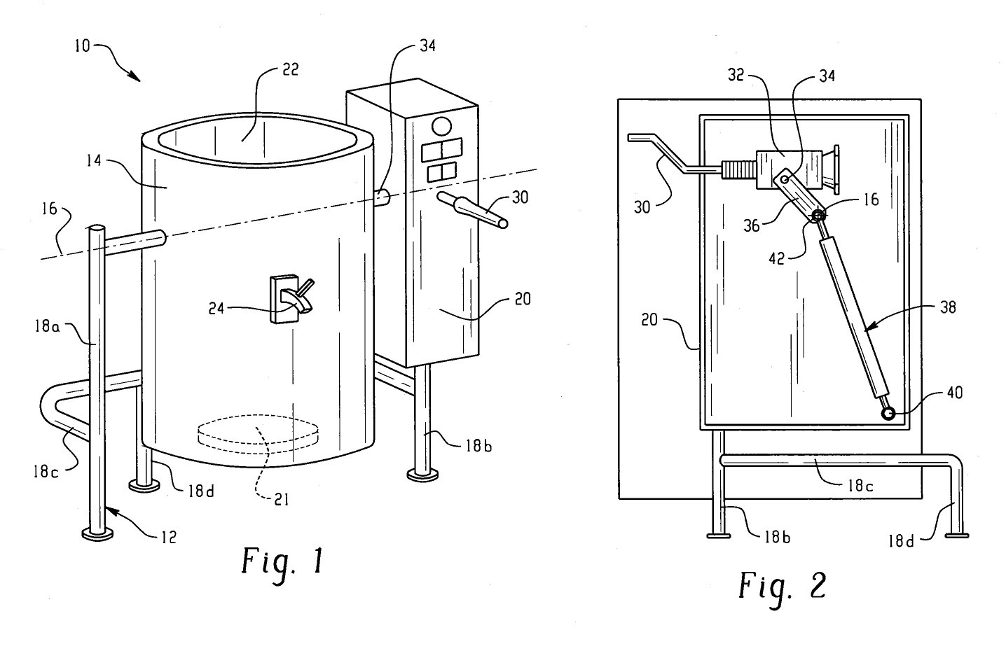

Referring to FIG. 1, one embodiment of a cooking kettle assembly 10 is shown. The assembly includes a frame 12 and a kettle body 14 pivotally mounted to the frame for rotation about a pivot axis 16. In the illustrated embodiment the frame 12 is formed by tubular portions 18a-18d (e.g., of tubular steel) and housing portion 20 (e.g., formed of sheet stainless and mounted on the tubulars). The kettle body may be of the jacketed type, typically be formed of stainless steel, with steam heat (e.g., water within the jacket is heated (e.g., by resistive heating element or gas burner or other heating mechanism shown schematically at 21) to produce steam or steam is delivered into the jacket). The kettle body has a top opening 22 for placement of product into a cooking volume of the kettle body. By way of example, the cooking volume may be 20 gallons, 40 gallons, 60 gallons or more. The pivot mount of the kettle body allows the kettle body to be rotated between the illustrated upright position for cooking and a tilted position for pouring food product from the steam kettle. The kettle body may also include a draw-off valve 24 that enables contents within the kettle to be dispensed without tilting of the kettle body.

A tilt actuator 30 is operatively connected for effecting pivot/rotation of the kettle body between the upright position and the tilted position. In the illustrated embodiment the actuator takes the form of a manually rotatable handle. However, it is recognized that powered actuators could also be used. The actuator 30 is operatively connected to a gear reducer 32, which is in turn operatively connected to rotate a shaft 34. The shaft 34 is aligned with the pivot axis and operatively connected to the kettle body 14 so that rotation of the shaft 34 effects rotation of the kettle body 14. A torque arm 36 is operatively connected so as to rotate with the kettle body 14 about the pivot axis 16 simultaneous with the kettle body. In the illustrated embodiment, one end of the shaft 34 is operatively connected to the kettle body 12, and the torque arm 36 is operatively connected toward the other end of the shaft 34, with the gear reducer engaging the shaft at a location between the two shaft ends. However, in other embodiments the torque arm could be provided at other locations in the assembly.

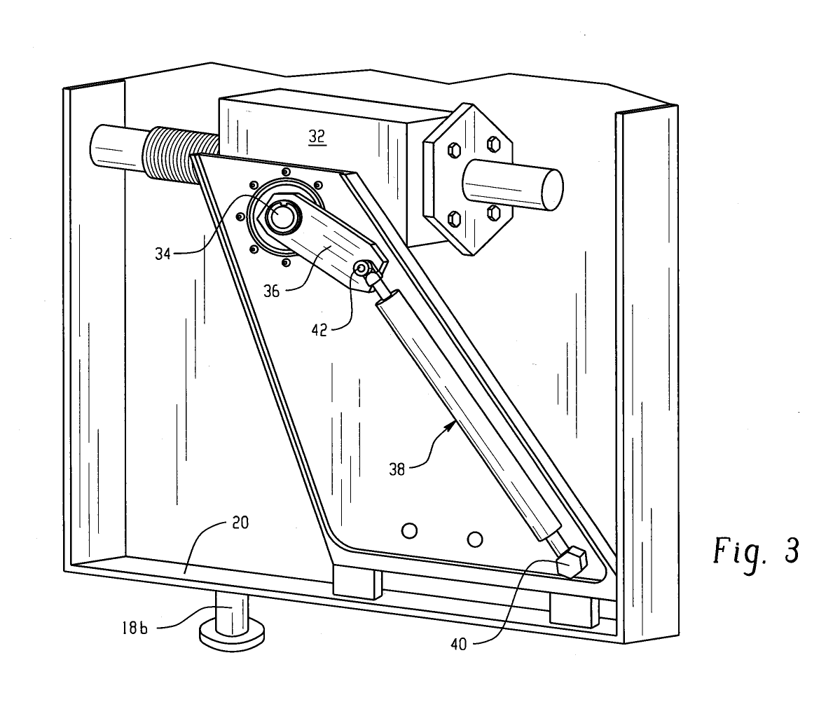

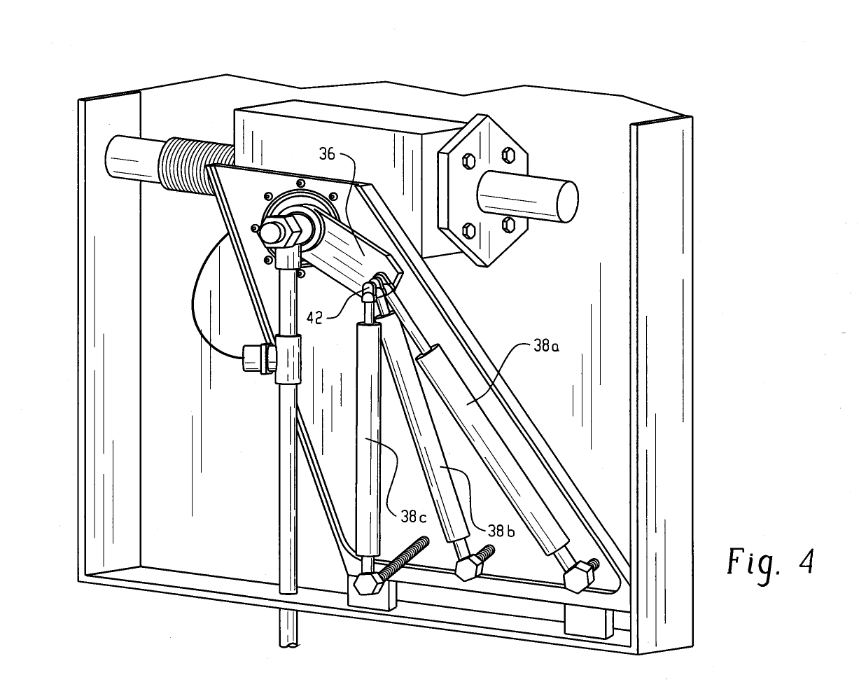

A linear damper 38 (e.g., hydraulic or pneumatic type) has one end pivotally mounted at a fixed location 40 on the frame, and an opposite end pivotally mounted to the torque arm at a location 42 spaced from the pivot axis 16. Due to the rotational movement of the torque arm, the damper 38 extends and retracts as the kettle body is rotated back and forth between the upright position and the tilted position. In the illustrated embodiment of FIGS. 2 and 3, a single damper 38 is provided. In one implementation of such embodiment, the damper is a multi-function damper that includes dampen on extension, dampen on compression and extension force functionality. However, in other implementations different damper types may be suitable (e.g., any of (i) extension force, (ii) dampen-on-extension, (iii) contraction force, (iv) dampen-on-contraction or (v) other type which combines two or more of the four preceding types into a single cylinder). Suitable dampers are available from a variety of manufacturers, including SUSPA Incorporated. In the illustrated arrangement, the damper 38 is in a compressed condition when the kettle body is upright. The damper 38 extends as the kettle body rotates from the upright position to the tilted position and the damper compresses as the kettle body rotates from the tilted position to the upright position.

The damper arrangement alleviates the chatter issue mentioned above. The linear damper 38 in combination with the torque/lever arm 36 reduces the torque (internal to the gear reducer 32) and dampens uneven rotary motion of the kettle body. In one example, it was found that the maximum torque contribution from the gear reducer to effect full rotation to the tilted position was reduced from approximately 160 ft-lb to approximately 80 ft-lb by use of a suitable damper, resulting in easier operation of the gear reducer hand crank 30 and a reduction the amount of shake in the kettle tilt motion. Thus, it may be desirable for the damper arrangement to be configured reduce the required torque contribution from the gear reducer by at least 25% (e.g., at least 35% or even at least 40%, such as 50% or more).

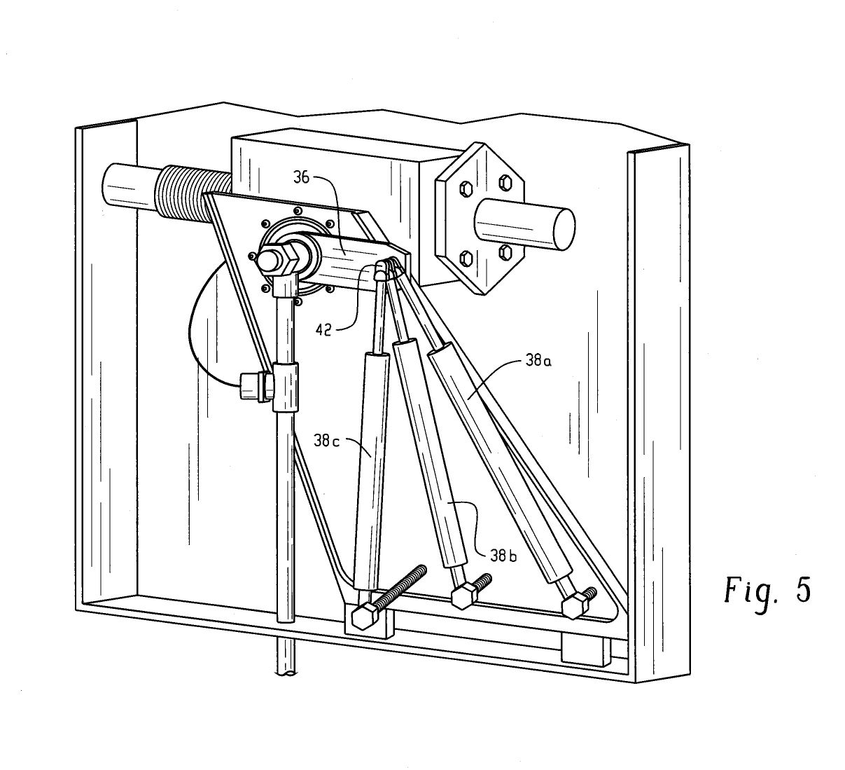

Referring now to FIGS. 4 and 5, an alternative damper arrangement includes three dampers 38a, 38b and 38c, each having one end pivotally connected to the frame at respective locations and opposite ends pivotally connected to the torque arm 36 at a common location 42. By way of example, damper 38a may be configured to dampen on extension, damper 38b may be configured to dampen on compression and damper 38c may be configured to provide extension force. All of the dampers are positioned so as to extend upon rotation of the kettle body from the upright position to the tilted position, and compress upon return movement of the kettle body. Other variations of damper arrangements are, of course, possible as well.

It is to be clearly understood that the above description is intended by way of illustration and example only, is not intended to be taken by way of limitation, and that other changes and modifications are possible. For example, while tiltable cooking kettles are primarily described above, it is recognized that the tilt arrangement with damper could be used in conjunction with any of tiltable kettles, tiltable brazing pans (e.g., rectangular or round) or any other tiltable cooking receptacle.

What is claimed is:

1. A cooking assembly, comprising:
a frame;
a cooking receptacle having a opening for placement of product into a cooking space of the cooking receptacle, the cooking receptacle pivotally mounted to the frame for rotation about a pivot axis between an upright position and a tilted position;
a damper arrangement operatively connected to dampen rotary motion of the cooking receptacle.

2. The cooking assembly of claim 1 wherein the damper arrangement includes a torque arm operatively connected for rotation with the cooking receptacle and at least one damper having a first end mounted to the frame and a second end mounted to the torque arm at a location spaced from the pivot axis.

3. The cooking assembly of claim 2 wherein the damper is of a linear type that is extendable and retractable as the cooking receptacle is rotated back and forth between the upright position and the tilted position.

4. The cooking assembly of claim 2 wherein the first end is pivotally mounted to a fixed location on the frame and the second end is pivotally mounted to the torque arm.

5. The cooking assembly of claim 1 wherein the damper arrangement includes a multi-function linear damper that includes dampen on extension, dampen on compression and extension force.

6. The cooking assembly of claim 1 wherein a gear reducer is operatively connected between a tilt actuator and the cooking receptacle.

7. The cooking assembly of claim 6 wherein the actuator is one of a manual handle or a powered device that is operatively connected to the gear reducer, the gear reducer is operatively connected to rotate a shaft that is aligned with the pivot axis and operatively connected to the cooking receptacle, the damper arrangement includes a torque arm operatively connected to the shaft for rotation with the shaft and at least one damper having a first end mounted to the frame and a second end mounted to the torque arm at a location spaced from the pivot axis.

8. The cooking assembly of claim 6 wherein the cooking receptacle is a kettle body, the actuator is a manual handle that is operatively connected to the gear reducer, the gear reducer is operatively connected to rotate a shaft that is aligned with the pivot axis and operatively connected to the kettle body, the damper arrangement includes a torque arm operatively connected to the shaft for rotation with the shaft and the kettle body and at least one damper having a first end mounted to the frame and a second end mounted to the torque arm at a location spaced from the pivot axis.

9. The cooking assembly of claim 6 wherein the cooking receptacle is a kettle body, the actuator is a powered device that is operatively connected to the gear reducer, the gear reducer is operatively connected to rotate a shaft that is aligned with the pivot axis and operatively connected to the kettle body, the damper arrangement includes a torque arm operatively connected to the shaft for rotation with the shaft and the kettle body and at least one damper having a first end mounted to the frame and a second end mounted to the torque arm at a location spaced from the pivot axis.

10. A cooking kettle assembly, comprising:
a frame;
a kettle body having a top opening for placement of product into a cooking volume of the kettle body, the kettle body pivotally mounted to the frame for rotation about a pivot axis between an upright position and a tilted position;
an actuator operatively connected for effecting pivot of the kettle body between the upright position and the tilted position;
a torque arm operatively connected so as to rotate with the kettle body about the pivot axis simultaneous with the kettle body;
a damper having a first end pivotally mounted at a fixed location on the frame, and a second end pivotally mounted to the torque arm at a location spaced from the pivot axis, the damper extendable and retractable as the kettle body is rotated back and forth between the upright position and the tilted position.

11. The cooking kettle assembly of claim 10 wherein the damper is a multi-function damper that includes dampen on extension, dampen on compression and extension force.

12. The cooking kettle assembly of claim 10 wherein a gear reducer is operatively connected between the actuator and the kettle body.

13. The cooking kettle assembly of claim 12 wherein the actuator is a manual handle that is operatively connected to the gear reducer, the gear reducer is operatively connected to rotate a shaft that is aligned with the pivot axis and operatively connected to the kettle body.

14. The cooking kettle assembly of claim 13 wherein the torque arm is operatively connected to the shaft.

15. The cooking kettle assembly of claim 14 wherein a first end of the shaft is operatively connected to the kettle body, the torque arm is operatively connected to a second end of the shaft and the gear reducer engages the shaft between the first end and the second end.

16. The cooking kettle assembly of claim 12 wherein the actuator is a powered device that is operatively to the gear reducer, the gear reducer is operatively connected to rotate a shaft that is aligned with the pivot axis and operatively connected to the kettle body.

17. The cooking kettle assembly of claim 10 wherein the damper is a first damper member, the fixed location is a first location and the cooking kettle assembly further comprises a second damper having a first end pivotally mounted at a second fixed location on the frame, and a second end pivotally mounted to the torque arm at a location spaced from the pivot axis, the second damper extendable and retractable as the kettle body is rotated back and forth between the upright position and the tilted position.

18. The cooking kettle assembly of claim 17 wherein the cooking kettle assembly further comprises a third damper having a first end pivotally mounted at a third fixed location on the frame, and a second end pivotally mounted to the torque arm at a location spaced from the pivot axis, the third damper extendable and retractable as the kettle body is rotated back and forth between the upright position and the tilted position, wherein the first damper is configured to dampen on extension, the second damper is configured to dampen on compression and the third damper is configured to provide extension force.

19. The cooking kettle assembly of claim 10 wherein the cooking volume is at least 20 gallons, and the assembly includes a heating system to heat contents with the kettle body.

20. The cooking kettles assembly of claim 10 wherein the damper extends as the kettle body rotates from the upright position to the tilted position and the damper compresses as the kettle body rotates from the tilted position to the upright position.
